(19) United States
(12) Patent Application Publication
(10) Pub. No.: US 2008/0075342 A1
(43) Pub. Date: Mar. 27, 2008

(54) Pet scanner with digital trigger

(76) Inventors: David M. Lazuka, Bolton, MA (US); Olof Johnson, Ashburnham, MA (US); Valery G. Zavarzin, Newton, MA (US)

Correspondence Address: FISH & RICHARDSON PC, P.O. BOX 1022, MINNEAPOLIS, MN, 55440-1022, US

(21) Appl. No.: 11/528,711

(22) Filed: Sep. 27, 2006

(51) Int. Cl. G06K 9/00

(52) U.S. Cl. 382/131

(57) ABSTRACT

A PET scanner includes detector modules, each of which has a detector for detecting a candidate signal; a module processor; and a digital trigger in communication with the detector module and the module processor. The digital trigger is configured to selectively trigger processing of the candidate signal by the module processor.

### FIELD OF INVENTION

This invention relates to positron emission tomography, and in particular, to data acquisition by a PET scanner.

### BACKGROUND

In positron emission tomography (“PET”), a radioactive material is injected into the patient. In the process of radioactive decay, this material emits positrons. These positrons travel through the patient until they encounter electrons. When a positron and an electron meet, they annihilate each other. This results in emission of two gamma ray photons (hereafter referred to as “gamma rays”) traveling in opposite directions. By detecting these gamma rays, one can infer the distribution of the radioactive material within the patient.

To detect the photons, the patient is placed along an axis of a ring of detector modules. Each detector module includes detectors that generate an electrical signal when illuminated by a gamma ray. A trigger associated with each detector module determines, on the basis of characteristics of the signal, whether the signal is indicative of an event, or whether the signal is a stray signal to be ignored.

If the trigger classifies the signal as an event, it causes a module processor associated with the detector module to save information about that event. This information includes information about which particular detector within the detector module actually detected the gamma ray, the time of detection, and an estimate of the energy of the detected gamma ray. The module processor compresses this information and includes it within an event data packet. This event data packet, together with many other event data packets created by module processors in other detector modules, is funneled toward a central coincidence processor.

The coincidence processor, which receives event data packets from all detector modules on the ring, processes that data. On the basis of the location of the detectors that detected a pair of events and the times of those events, the coincidence processor determines whether that pair of events resulted from an annihilation of a positron and electron within the patient. If the coincidence processor concludes that this is the case, it then saves the compressed information about each event for later use by an image reconstruction process.

### SUMMARY

In one aspect, the invention features a PET scanner having detector modules, each detector module including a detector for detecting a candidate signal; a module processor; and a digital trigger in communication with the detector module and the module processor. The digital trigger is configured to selectively trigger processing of the candidate signal by the module processor.

In some embodiments, the PET scanner includes a memory in communication with the digital trigger. The memory is configured to store samples of the candidate signal. A suitable memory in some cases includes a FIFO memory. In other cases, the memory includes a first FIFO memory for storing consecutive samples of the candidate signal separated by a first sampling interval, and a second FIFO memory for storing consecutive samples of the candidate signal separated by a second sampling interval.

Other embodiments include those in which the digital trigger is configured to execute, in parallel, a first qualifier for providing a first qualifier output representative of a classification of a candidate signal and a second qualifier for providing a second qualifier output representative of a classification of a candidate signal; and to cause the module processor to further process the candidate signal at least in part on the basis of the first and second qualifier outputs.

Among the embodiments of the PET scanner are those in which the digital trigger includes a single-stage digital trigger, those in which the digital trigger includes a multi-stage digital trigger, and those in which the digital trigger is configured to be re-programmable.

In other embodiments of the PET scanner, the digital trigger is configured to execute cascaded first and second qualifiers. The first qualifier has a first qualifier output. The second qualifier has a second qualifier input, which includes information provided by the first qualifier output, and a second qualifier output. The digital trigger causes the module processor to further process the candidate signal on the basis of the second qualifier output.

In some cases, the first qualifier is configured to generate first data indicative of the candidate signal, and second data indicative of an outcome of processing by the first qualifier. The second qualifier is configured to generate an output that depends in part on the second data.

In yet other embodiments, the digital trigger is configured to execute a first qualifier that recursively executes a second qualifier.

In other embodiments, the digital trigger is configured to execute an energy qualifier for classifying a candidate signal at least in part on the basis of a first sample set, and a timing qualifier for classifying a candidate signal at least in part on the basis of a second sample set. Each sample set includes samples from the candidate signal. Among these embodiments are those in which the first sample set includes samples obtained at a first sampling frequency and the second sample set includes samples obtained at a second sampling frequency that is greater than the first sampling frequency.

In another aspect, the invention features a method for causing a module processor to process a candidate signal by storing samples of a candidate signal in a memory; selectively retrieving samples from the memory; on the basis of the selectively retrieved samples, determining that the candidate signal is indicative of an event; and sending the module processor information identifying the candidate signal for processing.

In some practices, the method further includes modifying at least one rule used to determine that the candidate signal is indicative of an event.

In other practices determining that the candidate signal is indicative of an event includes executing a first process for classifying a candidate signal as being indicative of an event; executing a second process for classifying a candidate signal as being indicative of an event; and on the basis of an outcome of the first and second processed, classifying the candidate signal as an event.

Additional practices include those in which determining that a candidate signal is indicative of an event includes retrieving, from the memory, first and second sets of samples of the candidate signal, the first set including consecutive samples separated by respective first and sampling intervals, and on the basis of the first set, generating a first output classifying the candidate signal as being indicative of an event; and on the basis of the second set, generating a second output classifying the candidate signal as being indicative of an event.

Other practices of the invention include those in which determining that a candidate signal is indicative of an event includes retrieving, from memory, a set of samples of the candidate signal; executing a first process for classifying the candidate signal on the basis of the set of samples; and executing a second process for classifying the candidate signal at least in part on the basis of an output of the first process.

In another aspect, the invention features a computer-readable medium having encoded thereon software for executing the foregoing method for causing a module processor to process a candidate signal.

In another aspect, the invention features a computer-readable medium having encoded thereon software for execution by the digital trigger, the software including instructions that, when executed by the digital trigger, cause the digital trigger to cause processing of a candidate signal by the module processor.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and the accompanying figures, in which:

### BRIEF DESCRIPTION OF THE FIGURES

FIG. 1 shows a ring of detector modules;

FIG. 2 shows a digital trigger with parallel architecture; and

FIG. 3 shows a digital trigger with a serial architecture.

### DETAILED DESCRIPTION

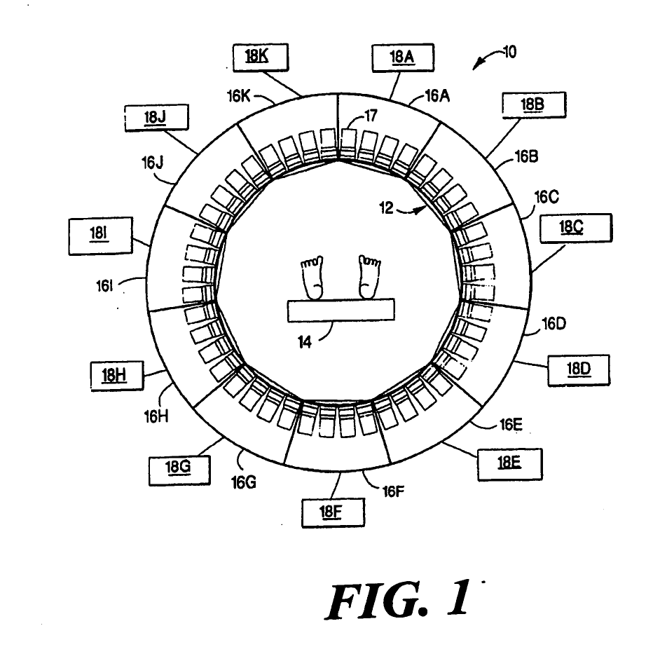

Referring to FIG. 1, a PET scanner 10 includes a ring 12 of detector modules 16A-K surrounding a bed 14 on which a patient is to lie. Each detector module 16A-K (hereinafter referred to as a “module”) includes several detector blocks 17. A detector block 17 typically includes four photo-multiplier tubes in optical communication with a scintillating crystal. The details of the construction of the photo-multiplier tubes and the scintillating crystal are not crucial to an appreciation of the invention and are therefore omitted for clarity.

A scintillating crystal is one that, when illuminated by a gamma ray, briefly generates visible light. This visible light is detected by the photo-multiplier tubes, which in turn generate an electrical signal indicative of detection of an incident gamma ray photon, hereafter referred to as detection of an “event.”

To image a portion of a patient with a PET scanner 10, one introduces a radioactive material into the patient. As it decays, the radioactive material emits positrons. A positron, after traveling a short distance through the patient, eventually encounters an electron. The resulting annihilation of the positron and the electron generates two gamma ray photons traveling in opposite directions. To the extent that neither of these photons is deflected or absorbed within the patient, they emerge from the patient and strike two of the detector modules 16A-K.

In particular, when one of these photons strikes a first detector module 16A, the other photon strikes a second detector module 16E, F, G, or H that is opposed to the first detector module. This results in two events: one at the first detector module 16A and the other at the opposed second detector module 16E, F, G, or H. Each of these events indicates the detection of a gamma ray photon. If these two events are detected at the first detector module 16A and the second detector module 16E, F, G, or H nearly at the same time, it is likely that they indicate an annihilation occurring somewhere along a line connecting first detector module 16A and the second detector module 16E, F, G, or H. If these two events are detected at the first detector module 16A and the second detector module 16E, F, G, or H at almost the same time, it is likely that they indicate an annihilation occurring somewhere along a line connecting first detector module 16A and the second detector module 16E, F, G, or H.

It is apparent that what is of interest in a PET scanner 10 are pairs of events detected by opposed detector modules 16A, 16E-F at, or almost at, the same time. A pair of events having these properties is referred to as a “coincidence.” In the course of a PET scan, each detector module 16A-K detects a large number of events. However, only a limited number of these events represent coincidences.

Associated with each detector module 16A-K is a module processor 18A-K that responds to events detected by its associated detector module 16A-K. A module processor 18A-K includes a processing element and a memory element in data communication with each other. The processing element includes an arithmetic logic unit (“ALU”) containing combinatorial logic elements for performing various logical operations, an instruction register, associated data registers, and a clock. During each clock interval, the processor fetches an instruction from the memory element and loads it into the instruction register. Data upon which the instruction is to operate is likewise loaded into the associated data registers. The structure and operation of the module processors 18A-K and their interaction with a coincidence processor is described in detail in Worstell, et al., U.S. Pat. No. 6,828,564, the contents of which are herein incorporated by reference.

A module processor 18 is intended to respond only to events detected by detector blocks 17. However, in many cases, detector blocks 17 generate spurious signals that arise from causes other than events. A trigger protects the module processor 18 from being overwhelmed by such signals. The function of a trigger is to reject those signals that are unlikely to represent an event, and to provide the remaining signals to the module processor 18.

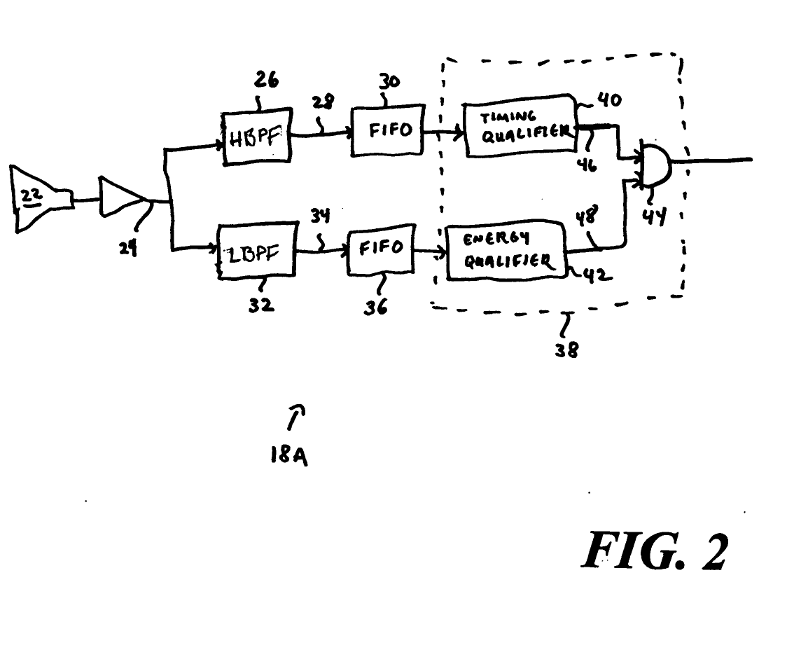

FIG. 2 illustrates the architecture of a trigger in more detail. The waveform of the signal received at each photo-multiplier tube 22, hereafter referred to as the “candidate signal 24,” is provided to a high band-pass filter 26. The resulting high band-pass filtered candidate signal 28 is then sampled with a first sampling frequency. These samples, which will be referred to as the “high-frequency samples,” are stored in a first memory 30, such as a FIFO memory.

Similarly, the candidate signal 24 is also provided to a low band-pass filter 32. The low band-pass filter has a pass-band that encompasses lower frequencies than the pass-band of the high band-pass filter. The resulting low band-pass filtered candidate signal 34 is then sampled at a second sampling frequency that is lower than the first sampling frequency. These samples, which will be referred to as the “low-frequency samples,” are stored in a second memory 36, such as a FIFO memory.

The two distinct memories 30, 36 shown in FIG. 2 only indicate that logically, there are two memories. These two logical memories can be embodied in one physical memory, or distributed among several physical memories.

In general, the passbands of the high and low band-pass filter 32, 26 will overlap to some extent. The passband of the high band-pass filter 26 should have an upper cut-off frequency below the point at which high frequency noise begins to impair the ability to identify the occurrence of the leading edge of the candidate signal 24. The passband of the low band-pass filter 32 is selected to provide sufficient bandwidth for obtaining information concerning the amplitude of the candidate signal, but without accepting high frequency components tainted by excessive noise.

The characteristics of the candidate signals 24 differ from time to time. In some cases, these characteristics are consistent with a detected gamma ray. In other cases, they are not. For example, some candidate signals 24 may indicate a voltage that is unusually low. Or, the time-evolution of a candidate signal 24 may be atypical of a gamma ray interaction.

A digital trigger 38 protects the module processor 18 from being overwhelmed by specious candidate signals, such as those that are likely to have arisen from something other than a gamma ray interaction. The digital trigger 38 is programmed to examine data derived from a candidate signal 24 and to then execute certain rules that classify that candidate signal 24 as likely to have arisen from a gamma ray interaction, or as being a stray signal.

The particular rules for classifying a candidate signal 24 are, in general, programmable. Because the rules are programmable, the digital trigger 38 can implement a variety of classification algorithms for determining whether a candidate signal is likely to indicate an event. The programmability of the digital trigger 38 enables the classification algorithm to be changed to suit changing circumstances, either by an operator or adaptively. For example, a qualifying condition might cause the classification algorithm to change by branching, considering additional inputs, or by changing parameters considered by the classification algorithm. In some implementations, the digital trigger 38 can be programmed or changed even while data processing continues, without interrupting the processing.

The digital trigger 38 need not rely on analog information in making a decision concerning a candidate signal 24. As a result, the rules executed by the digital trigger 38 are unconstrained by difficulties associated with manipulation and storage of analog information. Such difficulties include the degradation of analog information that often occurs during its manipulation and storage.

The digital trigger 38 is in data communication with one or both memories 30, 36. As a result, the programmable rules can readily exploit information from candidate signals other than a current candidate signal 24, or information from different parts of the waveform that makes up the current candidate signal 24. The digital trigger 38 can thus implement rules that classify a current candidate signal 24 on the basis of previous signals. Or, the digital trigger 38 can postpone classifying a candidate signal 24 until additional candidate signals have been acquired. This enables the digital trigger 38 to implement classification rules that depend on information not yet available as of the time a candidate signal 24 to be classified is received.

In the embodiment shown in FIG. 2, the digital trigger 38 exploits information derived from both the high frequency samples 28 and the low frequency samples 34. It does so by executing a timing qualifier process 40 (hereafter the “timing qualifier 40”) and an energy qualifier process 42 (hereafter the “energy qualifier 42”). The timing qualifier 40 classifies a candidate signal on the basis of the high frequency samples 28. The energy qualifier 42 classifies a candidate signal on the basis of the low frequency samples 34. A comparator 44, represented as an AND gate in FIG. 2, considers a candidate signal to represent an event only if both the timing qualifier 40 and the energy qualifier 42 agree that the candidate signal 24 is likely to represent an event.

Since the output of the timing qualifier 40 and the output of the energy qualifier 42 are available at different times, the comparator 44 is implemented by placing the earlier of the two outputs into a delay line. The delay line delays the earlier of the two outputs until the later one becomes available. At that point, the outputs of the energy qualifier 42 and the timing qualifier 40 are both available, and can therefore be compared.

One rule implemented by either or both the timing qualifier 40 and the energy qualifier 42 is a single-pair slope test. In implementing the single-pair slope test, the qualifier 40, 42 examines the slope associated with a pair of samples stored in the memory 30, 36. In some embodiments, these samples are consecutive. However, in other embodiments, these samples are separated by one or more other samples. If the resulting slope is in excess of a threshold, the qualifier 40, 42 classifies the candidate signal as being likely to represent an event. The resulting classification is represented by a logical output signal 46, 48 provided to the comparator 44.

Another rule implemented by either or both the timing qualifier 40 and the energy qualifier 42 is a multi-pair slope test. When executing a multi-pair slope test, the qualifier 40, 42 examines the slopes associated with two or more pairs of samples stored in the memory 30, 36. If the number of pairs having associated slopes in excess of a slope threshold exceeds a count threshold, then the qualifier 40, 42 classifies the candidate signal has being likely to represent an event. The resulting classification is represented by a logical output signal 46, 48 provided to the comparator 44.

The multi-pair and single-pair slope tests are useful for detecting the edge of the candidate signal waveform. By measuring the difference in slope at two different times, the qualifier 40, 42 decreases sensitivity to baseline shift. By appropriately re-programming the qualifier 40, 42, for example by defining different thresholds for the slope difference and by changing the times at which the slope differences are measured, one can tune the qualifier 40, 42 to accept or reject candidate signals on the basis of different ranges of slopes.

Other rules executed by a qualifier 40, 42 include those that correct for signal pile-up caused by receiving two candidate signals in rapid succession. In such cases, the tail of the earlier candidate signal may not have decayed sufficiently to avoid being added to the beginning of the later candidate signal. A qualifier 40, 42 corrects this by storing a tail amplitude for a candidate signal and causing a decaying fraction of this amplitude to be subtracted from a subsequent candidate signal. The rate of decay and the parameters required to trigger the use of tail cancellation are both programmable.

Other rules executed by a qualifier 40, 42 include those that correct for the reduced sensitivity of a photo-detector 22 at the periphery of its field of view. This reduction in sensitivity as one approaches the periphery of the field of view is referred to as “crowning.”

The digital trigger 38 thus uses samples in memory 30, 36 to make decisions concerning whether or not a candidate signal 24 represents a gamma ray interaction. The availability of such stored samples permits extensive and programmable processing of information before making a commitment to a particular decision. This renders practicable decision-making about a current sample on the basis of information embodied in preceding samples. Because samples are stored in memory 30, 36 until a decision is made, samples representing different times can be read from different portions of memory 30, 36 at any time, thereby enabling the rules implemented by the digital trigger 38 to be varied in complexity without altering the data storage requirements.

The foregoing features enable the digital trigger 38 to execute multiple independent processes in parallel, as shown in FIG. 2. For example, in FIG. 2, the timing qualifier 40 and the energy qualifier 42 do not interact with each other and can therefore execute independently of each other.

Although FIG. 2 shows specific types of qualifiers, namely an energy qualifier 42 and a timing qualifier 40, a digital trigger 38 is not restricted to executing those particular types of qualifiers. The energy and timing qualifiers 42, 40 are shown only to specifically describe a particular embodiment of a digital trigger 38. Nor is a digital trigger 38 limited to executing only two processes in parallel.

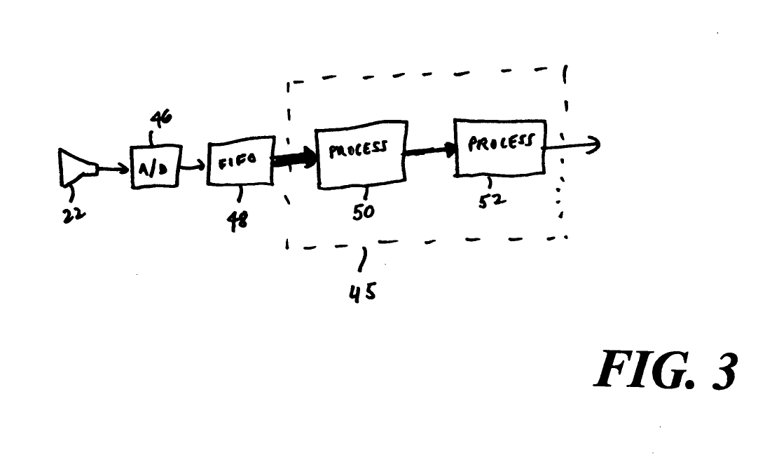

FIG. 2 shows one example of an architecture for a digital trigger 38. In particular, FIG. 2 shows an architecture in which two processes execute in parallel. However, other architectures are possible. One such architecture, shown in FIG. 3, is that of a multi-stage digital trigger 45 in which candidate signals are subjected to different tests by successive cascaded processes.

Referring now to FIG. 3, a multi-stage digital trigger 45 includes an A/D converter 46 for sampling candidate signals from a photo-multiplier tube 22. The samples are placed in a memory 48 in communication with a first process 50. The first process 50 implements a classification algorithm that disqualifies some fraction of the candidate signals on the basis of a relatively simple and rapid test. The first process 50 then forwards those candidate signals that passed this test to a second process 52, which executes a second test on the remaining candidate signals. The second process 52 disqualifies additional candidate signals and forwards the remaining candidate signals to the module processor 18.

The architecture shown in FIG. 3, in which two processes 50, 52 are cascaded, can be extended to more than two processes. In such cases, the winnowing continues, with each successive process executing progressively more time-consuming tests on fewer candidate signals.

At each stage, information concerning the outcome of a test on a candidate signal can be forwarded to the following stage for use by that stage. Those candidate signals that pass through all the stages, and hence “graduate” from the digital trigger 38, are optionally tagged with a weighting coefficient to be used by the coincidence processor in determining whether that event is likely to be part of a coincidence.

A multi-stage digital trigger 45 as shown in FIG. 3 can also be implemented using multi-level recursion. In this case, a process recursively calls another process, with that called process potentially calling yet another process.

The parallel, serial or cascaded, and recursive architectures described above can be combined into a hybrid architecture. For example, a multi-stage digital trigger can incorporate stages in which processes execute independently as shown in FIG. 2. Or, one or more stages of a multi-stage digital trigger 38 can execute nested processes, and therefore have attributes of a multi-level recursive process.

The multi-stage architecture for a digital trigger 45, as shown in FIG. 3, avoids the need to decide, on the basis of a single inspection, whether or not a candidate signal is to be considered an event suitable for forwarding to the coincidence processor. By providing a multi-stage digital trigger 45, one can subject selected candidate signals to increasing levels of scrutiny. This results in decisions that are more likely to be correct.

It is evident that those skilled in the art may now make numerous modifications of and departures from the apparatus and techniques herein disclosed without departing from the inventive concepts. Consequently, the invention is to be construed as embracing each and every novel feature, and novel combination of features, present in or possessed by the apparatus and techniques herein disclosed and limited only by the spirit and scope of the appended claims.

Having described the invention, and a preferred embodiment thereof, what we claim as new, and secured by letters patent is:

1. A PET scanner comprising:
a plurality of detector modules, each detector module including
a detector for detecting a candidate signal;
a module processor; and
a digital trigger in communication with the detector module and the module processor, the digital trigger being configured to selectively trigger processing of the candidate signal by the module processor.

2. The PET scanner of claim 1, further comprising a memory in communication with the digital trigger, the memory being configured to store samples of the candidate signal.

3. The PET scanner of claim 2, wherein the memory comprises a FIFO memory.

4. The PET scanner of claim 2, wherein the memory comprises a first FIFO memory for storing consecutive samples of the candidate signal separated by a first sampling interval, and a second FIFO memory for storing consecutive samples of the candidate signal separated by a second sampling interval.

5. The PET scanner of claim 1, wherein the digital trigger is configured:
to execute, in parallel, a first qualifier for providing a first qualifier output representative of a classification of a candidate signal and a second qualifier for providing a second qualifier output representative of a classification of a candidate signal; and
to cause the module processor to further process the candidate signal at least in part on the basis of the first and second qualifier outputs.

6. The PET scanner of claim 1, wherein the digital trigger comprises a single-stage digital trigger.

7. The PET scanner of claim 1, wherein the digital trigger comprises a multi-stage digital trigger.

8. The PET scanner of claim 1, wherein the digital trigger is configured
to execute cascaded first and second qualifiers,
the first qualifier having a first qualifier output, and
the second qualifier having a second qualifier input and a second qualifier output,
the second qualifier input including information provided by the first qualifier output; and
to cause the module processor to further process the candidate signal on the basis of the second qualifier output.

9. The PET scanner of claim 8, wherein the first qualifier is configured to generate
first data indicative of the candidate signal, and
second data indicative of an outcome of processing by the first qualifier; and
wherein the second qualifier is configured to generate an output that depends in part on the second data.

10. The PET scanner of claim 1, wherein the digital trigger is configured to execute a first qualifier that recursively executes a second qualifier.

11. The PET scanner of claim 1, wherein the digital trigger is configured to execute
an energy qualifier for classifying a candidate signal at least in part on the basis of a first sample set of samples from the candidate signal, and
a timing qualifier for classifying a candidate signal at least in part on the basis of a second sample set of samples from the candidate signal.

12. The PET scanner of claim 11, wherein the first sample set includes samples of the candidate signal obtained at a first sampling frequency and the second sample set includes samples of the candidate signal at a second sampling frequency that is greater than the first sampling frequency.

13. The PET scanner of claim 1, wherein the digital trigger is configured to be re-programmable.

14. In a PET scanner, a method for causing a module processor to process a candidate signal, the method comprising:
storing samples of a candidate signal in a memory;
selectively retrieving samples from the memory;
on the basis of the selectively retrieved samples, determining that the candidate signal is indicative of an event; and
sending the module processor information identifying the candidate signal for processing.

15. The method of claim 14, further comprising modifying at least one rule used to determine that the candidate signal is indicative of an event.

16. The method of claim 14, wherein determining that the candidate signal is indicative of an event comprises:
executing a first process for classifying a candidate signal as being indicative of an event;
executing a second process for classifying a candidate signal as being indicative of an event; and
on the basis of an outcome of the first and second processed, classifying the candidate signal as an event.

17. The method of claim 14, wherein determining that a candidate signal is indicative of an event comprises:
retrieving, from the memory, a first set of samples of the candidate signal, the first set including consecutive samples separated by a first sampling interval, and
retrieving, from the memory, a second set of samples of the candidate signal, the second set including consecutive samples separated by a second sampling interval;
on the basis of the first set, generating a first output classifying the candidate signal as being indicative of an event; and
on the basis of the second set, generating a second output classifying the candidate signal as being indicative of an event.

18. The method of claim 14, wherein determining that a candidate signal is indicative of an event comprises:
retrieving, from memory, a set of samples of the candidate signal;
executing a first process for classifying the candidate signal on the basis of the set of samples; and
executing a second process for classifying the candidate signal at least in part on the basis of an output of the first process.

19. A computer-readable medium having encoded thereon software for causing a module processor to process a candidate signal, the software comprising instructions
storing samples of a candidate signal in a memory;
selectively retrieving samples from the memory;
on the basis of the selectively retrieved samples, determining that the candidate signal is indicative of an event; and
sending the module processor information identifying the candidate signal for processing.

20. A computer-readable medium having encoded thereon software for execution by a digital trigger in a PET scanner having a module processor, the software including instructions that, when executed by the digital trigger, cause the digital trigger to cause processing of a candidate signal by the module processor.
